(19) United States
(12) Patent Application Publication
(10) Pub. No.: US 2005/0099081 A1
(43) Pub. Date: May 12, 2005

(54) Disk alternator

(76) Inventor: Louis Obidniak, Laval (CA)

Correspondence Address: MERCHANT & GOULD PC, P.O. BOX 2903, MINNEAPOLIS, MN, 55402-0903, US

(21) Appl. No.: 10/911,867

(22) Filed: Aug. 5, 2004

(30) Foreign Application Priority Data
Aug. 5, 2003 (CA) 2,436,369

(51) Int. Cl. H02K 21/12; H02K 16/00

(52) U.S. Cl. 310/156.36; 310/268

(57) ABSTRACT

A power disk alternator includes a rotor arranged to rotate about an axis, having a circular cross section, and having at least two disks facing each other and defining at least one gap therebetween. The rotor has a shaft connected to an external source for driving the shaft in rotation about the axis. A circular array of magnetized elements is located in equally arcuately spaced relation adjacent to the periphery of each disk, each of the magnetized elements having surfaces of opposite polarity and being disposed in side-by-side relationship in an alternating polarity configuration. Magnetized elements of one disk face magnetized elements of the other disk of opposite polarity to create between the two disks in the air gap the magnetic fields of the opposite polarities. The alternator also includes a stator having at least one fixed disk made of a nonmetallic material having a conductor path on at least one surface thereof, each of the stators being located in one of the at least one air gap. A connector is provided for connecting the conductor path to a load. When the external source drives the shaft in rotation about the axis, the rotor rotates and the resulting rotating magnetic field induces a current in the conductor path.

### FIELD OF THE INVENTION

The present invention relates to an alternator which includes fixed coil disks subjected to a variable magnetic flux resulting from rotating magnetic disks and have an alternating emf induced in them. The coils' holding disk is manufactured from plastic material; no metallic cores are involved to hold the coils. Conductors are used to remove the power from the stationary coils, requiring no commutator or slip ring. The disk alternator of the present invention is based on the physical principle of electromagnetic induction, magnetic fields, conductors of the generating coils and movement. All three must be incorporated into a machine that generates current.

The advancements in alternator design improvement are becoming increasingly important, with continuing, increasing demands for lightweight, durable, alternator capable to operate at low and high speed, mainly for installations like windmills, diesel engines, reciprocating steam engines and many other similar power generators.

### BACKGROUND OF THE INVENTION

The present invention relates to a disk alternator that produces an alternating current output based, at least in part, upon the use of unique arrangement and configuration of permanent magnets and conductors—with no iron core—and which have a markedly different physical and mechanical configuration as compared with the conventional alternators.

Many devices exist which utilize a well-known principle that electric generators are rotating machines that transform mechanical energy into electrical energy. Basically, all alternators operate on the principle of electromagnetic induction, that is they work because a conductor is moving through a magnetic field, or a magnetic field is moving past a conductor and inducing a motional force “emf” in the conductors. These alternators typically have a closely wound, rectangular coil which rotates about an axis which is perpendicular to a uniform magnetic field provided by the electromagnets or by permanent magnets. The coils themselves are wound on an iron cylinder or armature, which can be fixed or rotating. The magnetic field is concentrated in the iron core. The speed of rotation is directly proportional to the frequency of the alternating current in most alternators. The armature, often called the stator, is the stationary member, and the magnetic field is rotating. The generated “emf” induced in coil is computed from the rate of change of magnetic flux through the core or from the velocities of the conductors traversing the magnetic field. This applies to any coil of any shape moving perpendicularly to a uniform magnetic field.

The changing magnetic fields will induce a magnetic field in a soft ferromagnetic core, magnetizing it and interacting with the coil conductors. The soft iron core is required only to support the coil and to conduct magnetic flux through the coil's conductors, and is not an operating member of current generation, unlike the magnetic flux itself. The iron core is actually a source of losses due to the heating, hysteresis and braking (cogging) of moving magnetic fields.

The presently built alternators, in order to be effective in power conversion, require a high speed of coil movement with respect to the magnetic field. However there are many plants having low operating speed, such as reciprocating power plants, steam or diesel engines, water or windmills, etc. In order to be effective, the output rotation of such power plants must be increased by various mechanical means, representing an additional source of losses and maintenance requirements.

Evaluation of existing alternator designs reveals a design whereby steel laminated cores are used to support the coils and create a flux conduction path forward to the next pole. Great care is used to reduce eddy currents, heat buildup, by stacking many insulated thin layers in these core components. They are essential in conventional alternators to conduct magnetic flux to the next pole, also to mechanically hold the coils. It can be said that the conventional alternators use polar coordinate design methodology. This concept has evolved over the last 100 years to the point where the technology is unchanged, but the industrial markets show a great need for the design of an alternator capable to operate at low and high speed.

### SUMMARY OF THE INVENTION

Thus it is an object of the present invention to provide an alternator in which the magnetic flux of rotor's disk is maintained at its maximum and its stationary disk conductors have no ferromagnetic cores.

The disk alternator incorporates an innovative approach to the generation of an electromagnetic force. Basically the strategy switches from polar to rectangular coordinate generating “emf” not through angular flux conduction but linearly through the vertical axis. The disk alternator obtains its small air gap by stacking multiple thin disks supporting the conductor combination. The innovation is to eliminate the steel core and thus reduce eddy currents and all of the associated losses. Conventional alternators have changed very little since their conception. Changes have come in manufacturing techniques and improvements in material science only.

The present invention's goal is to fulfill the need for a cost effective alternator, designed to be reliable through all changing operating conditions, namely, that it should be able to withstand the runaway operation and work with minimal maintenance. It has been achieved through the unique design features as follows:
The power disk alternator is designed to be direct driven, thus eliminating the need for costly gearboxes.
Reduced maintenance through fewer operating components (no gearboxes, no chain drives etc.).
Safer operating conditions since there is no step-up gear ratio that can cause the centrifugal alternator's failure in the conventional high-speed alternators.
Reduced-manufacturing cost based on coreless alternator design.
Increased efficiency through an absence of iron core and its heating caused by eddy currents.
Easily configurable design, which can be tailored using little redesigning or using existing standard components for higher or lower load conditions using a unique stackable design methodology.
Flexible design for operating output frequency based on power shaft operating rpm.
Reduced maintenance cost based on a simple assembly, and disassembly procedures.

It is an object of the present invention to provide an alternator wherein the magnetic field strength is substantially uniform. It is another object of the present invention to provide a rotary magnetic device having substantially uniform magnetic polarity about the arc of travel. In accordance with a preferred embodiment of the invention, the power disk alternator comprises:
a rotor means arranged to rotate about an axis, having a circular cross section, and comprised of at least two disks facing each other and defining at least one gap therebetween, said rotor means having a shaft connected to an external source for driving the shaft in rotation about said axis;
a circular array of magnetized elements located in equally arcuately spaced relation adjacent to the periphery of each disk, each of said magnetized elements having surfaces of opposite polarity and being disposed in side-by-side relationship in an alternating polarity configuration, magnetized elements of one disk facing magnetized elements of the other disk of opposite polarity to create between the two disks in the air gap the magnetic fields of the opposite polarities; and
a stator means comprising at least one fixed disk made of a nonmetallic material having a conductor path on at least one surface thereof, each of said stator means being located in one of said at least one air gap; and
connection means for connecting said conductor path to a load,
wherein when said external source drives said shaft in rotation about said axis, said rotor means rotates and the resulting rotating magnetic field induces a current in said conductor path.

Further objects of the present invention will appear as the description proceeds.

### BRIEF DESCRIPTION OF THE DRAWINGS

The above mentioned and other features are objects of this invention, and the manner of attaining them will become more apparent and invention itself will be better understood by reference to the following description of a preferred embodiment of the invention taken in conjunction with accompanying drawings, wherein:

FIG. 1 is a top view of rotary magnets disks and their magnetic fluxes flow orientation and in between them a fixed conductor disk, in accordance with one preferred embodiment of the invention, illustrating the conductors in series connection and their current flow induced by the movement of the magnets disk. For the clarity of view the air gap is enlarged to more easily demonstrate the magnetic fluxes between the magnets.

FIG. 2 is an elevational view of fixed conductors disk with its radially oriented conductors attached to a flat nonmagnetic material. The rotating disks have their magnets in relation to each other so aligned, that the north pole of one magnet is facing the south pole of other disk's magnet, providing a strong magnetic field with constant density and small air gap between the two rotating disks. The mean diameter of these magnets is such as to assure relative large circumferential speed in relation to radially oriented conductors. This assembly assures a high rate of change of magnetic flux through the conductors. The conductors are connected in parallel, and led to outside load without the need of a slip ring.

FIG. 3 is a plane view of rotating disks with their permanent magnet elements mounted on nonmagnetic flat disks. The magnets are arranged in side-by-side relationship, disposed radially, outwardly from the rotor's axis, mounted flat on the surface of the disk. The surface of one magnet's polarity is besides an opposite polarity of the neighboring magnets surface.

FIG. 4A is a cross-sectional view and FIG. 4B is an exploded view of multiple magnetic disks stacked one on top of another forming small air gaps in between them. The fixed conductor disks are located in the air gaps between the rotating magnetic disks forming together power disks assemblies. This stacking of a multitude of power disks can supply more of electric power, using existing standard elements.

### DESCRIPTION OF A PREFERRED EMBODIMENT

A disk alternator according to the present invention is a rotary magnet device composed of a rotor and stator disks designed to be direct driven, thus eliminating the need for costly gearboxes. The rotor means comprises rotating circular array disks with permanent magnets which are arranged in side by side relationship, disposed radially, outwardly from the rotor's axis, and which are arranged on the surface of the disk, with the surface of one magnet's polarity besides an opposite polarity of the neighboring magnet surface, thereby forming circumferentially, variable direction of the magnetic flux emanating from the surfaces of the magnets.

The rotating magnets disk poles form a gap between them with a generally uniform magnetic flux density there across.

The stator disks means includes one, two or more fixed, flat nonmetallic disks on the surface of which a predetermined number of flat conductors with no iron core are disposed radially outwardly from the disk's center.

One of the stator conductor disks can be disposed fixedly in the air gap formed by two rotating magnets disks. The second and the third conductor disks can be in the outside in relation to the rotating magnetic disks. The rotating magnetic disks move their magnetic fields in relation to the fixed power conductor (or stator) disks, and an alternating current is induced in the conductors.

This alternator that produces an alternating current output is based, at least in part, upon the use of unique arrangement and configuration of permanent magnets and conductors with no iron core, and which have a markedly different physical and mechanical configuration as compared with the conventional alternators. The disk alternator was invented to fulfill the need for a lightweight low speed alternator, mainly for installations like windmill power generators. Having an ironless construction, a large amount of weight, space and heat can be removed. Today's alternators must be operated at a relatively high speed to be efficient. However, as mentioned previously, industrial markets show a need for low speed alternators.

The invention disclosed herein maximizes the derivation of magnetic flux energy conversion into the induced electrical energy, and this from the stored energy stored in the interacting fields of the permanent magnets.

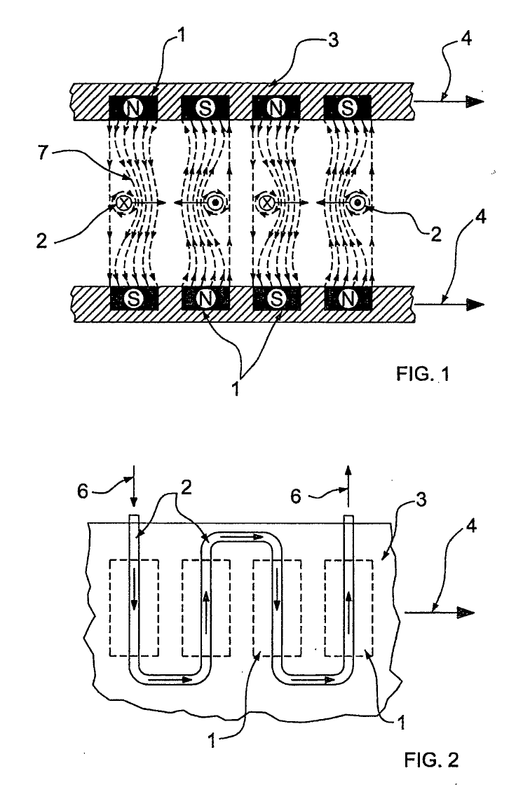

FIG. 1 illustrates the principle of the present invention. In one embodiment of this invention a rotating rotor means (3) is comprised of at least two disks defining at least one air gap there between. The size of the air gap can be selectively adjusted. The disks are provided with permanent magnets (1) about the periphery of the disks. The permanent magnets are arranged in side-by-side relationship, in alternating polarities, as shown in FIG. 1, and are equally spaced there between. Magnets of one disk face magnets of the other disk of opposed polarity, as shown in FIG. 1.

The rotor means rotate in direction (4) and are connected to a shaft, which is in turn connected to a power generating source.

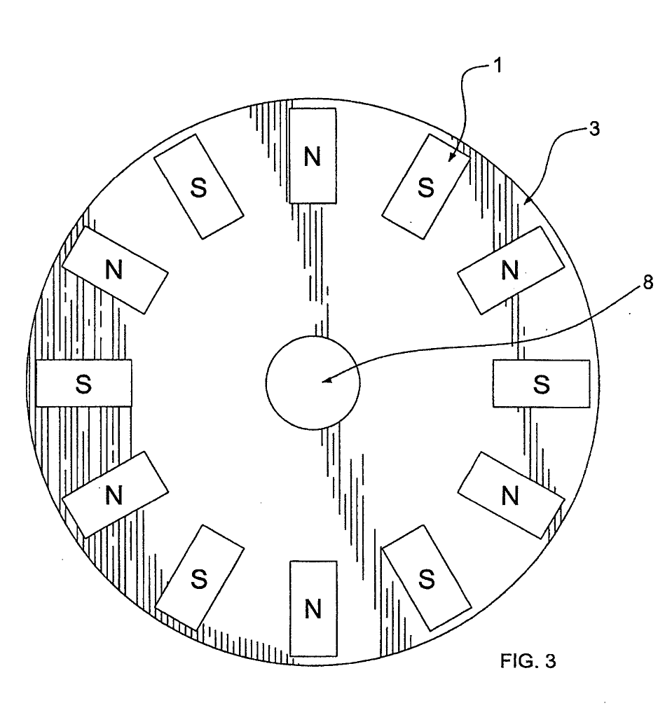

The alternator of the present invention also includes at least one fixed stator means, comprising a disk having a circuit path on its periphery, as shown in FIG. 2. As the rotor disks are driven in rotation (4), they sweep their magnetic fields (7) across stationary conductors (2), mounted on a flat non-ferrous disk. The movement of the magnetic flux across the conductors induces a current flow into a load (6). The conductors (2) are connected in series and led to outside use without the need of a slip ring, due to the stationary character of the conductor disk (2).

As mentioned previously, the rotating magnets move their magnetic fields (7) across stationary conductors mounted on the flat nonmagnetic disk. A series of conductors exposed to a uniform magnetic field with varying direction and rotating with constant angular velocity develops an alternating “emf”. When a number of pairs of magnetic poles are spaced around the circumference of rotating disks then each conductor on the fixed disk is swept across by the varying magnetic field (7) and a motional “emf” is induced in it, in one direction as the field's north pole passes the conductors, and in the opposite direction as the south pole is moved across the conductors. The induced “emf” is therefore alternating, and the number of complete cycles per each revolution equals the number of passing poles. The multiple structure of the magnetic poles enables a sufficiently high frequency to be attained without an unduly high velocity of rotation for the rotor disks.

In a preferred embodiment of the invention, the magnetic elements are angularly adjustable relative to each other to have maximum exposure of the magnetic elements between them and thus to maximize the magnetic field characteristic thereby controlling the degree of interaction between the magnetic fields (7).

FIG. 2 illustrates a plurality of conductor elements, circularly disposed on the surface of non-magnetic, fixed disk. The conductor wires (2) are connected in series, and led to the outside use of a load (6). The conductor wires have a radial portion, the length of which is at least equal to the size of the magnets, and a circumferential portion connecting two radial portions together, which preferably lie outside of the magnetic field. This is schematically shown in FIG. 2, where the dotted lines represent the magnets. In a preferred embodiment of the invention, the radial portions of the conductor are equally spaced.

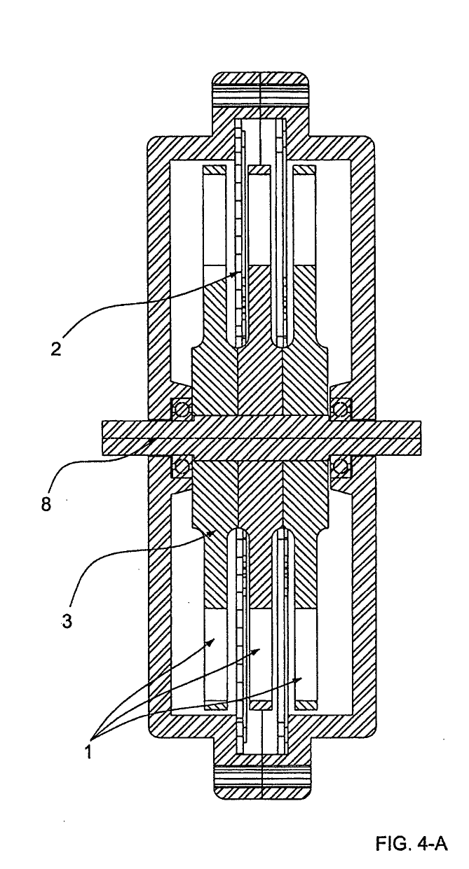

FIG. 3 shows a plurality of flat magnets (1) circularly disposed about, and connected to a flat nonmagnetic disk (3). The disk (3) is rotationally connected to shaft (8), which, using an outside power source, is rotating the disk in the preferred direction. The magnets (1) are radially oriented in a side-by-side relationship on the surface of the disk (3), and the surface polarity of one magnet faces the opposing polarity of the neighboring magnet's surface, as better shown in FIG. 1. The magnets are proximate each other and their magnetic fluxes (7) are concentrated and provide a strong magnetic field with constant density.

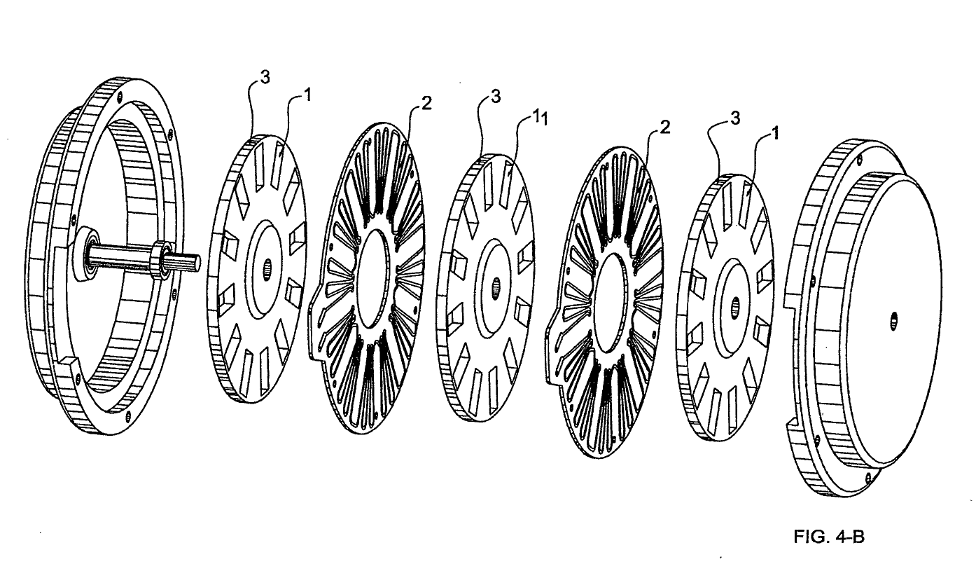

Referring to FIG. 4-A & B, the invention is illustrated as having three rotors (3) on a single common shaft (8) and two-fixed conductor disks (2). It should be understood that more of such stator-rotor units might be used as necessary or desirable. Such assemblies will utilize the standard rotor and stator disks produced by mass production means, and they will be stacked together to increase the power supplied by the alternator.

Although the above description refers to the rotor disks with their circular array of magnetized elements (1), these elements may be arranged in any geometric closed shape. The arrays of the elements (1) and (3) can be replaced by a solid, generally ring-shaped members. As shown in FIG. 4B, the conductor paths on stator (3) can also be printed on the disk, using circuit-printing technology. The ring shaped members can be magnetized at an angle to their respective planes i.e. the magnetic fields can be angularly disposed relative to the respective planes.

While this invention has been described as having a preferred embodiment, it will be understood that it is capable of further modifications in the shape of the state conductors disk and rotor's magnetic disk and their orientation with respect to each other. Further modifications may be made in the construction materials for magnetic elements or otherwise to enhance operation or reliability or to reduce the cost. Accordingly, while the invention has been described with reference to a specific configuration, it is to be understood that this disclosure is to be interpreted in it broadest sense and encompass the use of equivalent apparatus.

Therefore this application is to cover any variation, use or adaptation of the invention following the general principle thereof and including such departures as come within known or customary practice in the art to which this invention pertains and falls within the limits of the appended claims.

1. A power disk alternator comprising:
a rotor means arranged to rotate about an axis, having a circular cross section, and comprised of at least two disks facing each other and defining at least one gap therebetween, said rotor means having a shaft connected to an external source for driving the shaft in rotation about said axis;
a circular array of magnetized elements located in equally arcuately spaced relation adjacent to the periphery of each disk, each of said magnetized elements having surfaces of opposite polarity and being disposed in side-by-side relationship in an alternating polarity configuration, magnetized elements of one disk facing magnetized elements of the other disk of opposite polarity to create between the two disks in the air gap the magnetic fields of the opposite polarities; and
a stator means comprising at least one fixed disk made of a nonmetallic material having a conductor path on at least one surface thereof, each of said stator means being located in one of said at least one air gap; and
connection means for connecting said conductor path to a load,
wherein when said external source drives said shaft in rotation about said axis, said rotor means rotates and the resulting rotating magnetic field induces a current in said conductor path.

2. The power disk alternator according to claim 1 wherein said disks of said rotor means are adjustable to selectively vary the size of each of said at least one air gap.

3. The power disk alternator according to claim 1, wherein said magnetic elements are angularly adjustable relative to each other to have maximum exposure of said magnetic elements between them and thus to maximize the magnetic field characteristic thereby controlling the degree of interaction between said magnetic fields.

4. The power disk alternator of claim 1, wherein said conductor path is comprised of a plurality of radial portions extending from the center to the circumferential periphery, said radial portions being equally spaced and connected in series.

5. The power disk alternator according to claim 1, wherein said alternator comprises three rotor disks and two stator disks, a stator disk being located in each of said air gaps.

6. The power disk alternator according to claim 1, wherein said conductor path is flat.
